(19) United States
(12) Patent Application Publication
(10) Pub. No.: US 2003/0077512 A1
(43) Pub. Date: Apr. 24, 2003

(54) Electrolyte for alkaline rechargeable batteries

(76) Inventors: Allen Charkey, Brookfield, CT (US); Xuejun Cao, Monsey, NY (US); Hanlin Zhang, Danbury, CT (US)

Correspondence Address: ROBIN BLECKER & DALEY, 330 MADISON AVENUE, 2ND FLOOR, NEW YORK, NY, 10017, US

(21) Appl. No.: 09/982,318

(22) Filed: Oct. 18, 2001

(51) Int. Cl. H01M 10/26; H01M 4/50; H01M 4/52; H01M 4/54; H01M 12/06

(52) U.S. Cl. 429/207; 429/223; 429/219; 429/224; 429/221; 429/29

(57) ABSTRACT

An electrolyte containing an aqueous solution having potassium hydroxide and potassium pyrophosphate dissolved therein. The electrolyte is used as electrolyte for nickel-zinc alkaline rechargeable batteries.

### BACKGROUND OF THE INVENTION

This invention relates to an electrolyte for electrochemical energy storage devices and, in particular, to an electrolyte for rechargeable batteries with zinc negative electrodes.

Many types of alkaline rechargeable batteries with zinc negative electrodes are known and have been used in a variety of industrial and commercial applications such as electric scooters, golf carts, electric aid bicycles and etc. The typical rechargeable batteries with zinc negative electrodes include nickel-zinc, silver-zinc, zinc-oxygen, zinc-air and zinc-mercuric oxide batteries.

During discharge of these batteries, zinc is converted to zinc oxide or hydroxide, which is soluble in the alkaline electrolyte. During charge, the dissolved zinc ion is re-plated onto the electrode. However, the zinc is not necessarily re-plated back to the same place. As a result, there is a redistribution of zinc active material over the surface of the negative electrode. This phenomenon is known as zinc shape change and results in the zinc active materials being concentrated in the middle to bottom area of the electrode. The battery, therefore, may exhibit low discharge capacity and high-rate capability, reduced cycle life and premature cell failure.

The complex nature of the zinc redistribution process makes it very hard to control. Many approaches have been tried including a variety of electrode additives, electrolyte additives, separator types and battery designs. Forming calcium zincate has proved to be the most effective way of realizing a long cycle life zinc rechargeable battery.

U.S. Pat. No. 3,516,862 issued to Van der Grinten and also U.S. Pat. No. 5,460,899 issued to Allen Charkey disclose methods of making a calcium oxide or hydroxide/ zinc oxide electrode in a sealed nickel-zinc cell. In both cases, zinc oxide and calcium oxide or hydroxide are mixed together and calcium zincate is formed in-situ in the alkaline electrolyte-activated cell.

U.S. Pat. No. 5,863,676 issued to Allen Charkey, discloses a method for externally forming calcium zincate and utilizing the calcium zincate as active material for nickel-zinc rechargeable batteries. A 12 V nickel-zinc rechargeable battery utilizing the above technology has achieved 500 cycles at C/3 rate 100% DOD.

Calcium zincate is identified by X-ray diffraction as having the structural formula Ca[Zn(OH)₃]₂.2H₂O. The relatively insoluble structure effectively binds the zincate ion, keeping it from getting into the bulk electrolyte. However, calcium zincate is stable only under a low concentration of electrolyte, the preferable concentration being 20% potassium hydroxide. The zincate will gradually decompose into Zn(OH)₄²⁻ and calcium hydroxide in an electrolyte with a concentration higher than 25%. On the other hand, a low concentration electrolyte has a low ionic conductivity and a relatively high freezing point. This prevents a battery employing such an electrolyte from being used at low temperature. In particular, such a battery cannot deliver any of its capacity at a temperature below −25° C.

It is, therefore, an object of the present invention to provide an electrolyte for a rechargeable battery with a zinc negative electrode which does not suffer from the above disadvantages.

It is a further object of the present invention to provide an electrolyte for a rechargeable battery with a zinc negative electrode which possesses a low freezing point and promotes formation of calcium constituent at higher electrolyte concentration.

### SUMMARY OF THE INVENTION

In accordance with the principles of the present invention, the above and other objectives are realized in an electrolyte for a rechargeable battery with a zinc negative electrode comprising an aqueous solution and potassium hydroxide and potassium pyrophosphate dissolved in the aqueous solution. In further accord with the invention, the potassium pyrophosphate is preferably present in a range of from 0.5 to 40 weight percent of the aqueous solution, and, more preferably, is present in a range of from 0.5 to 10 weight percent of the aqueous solution. The potassium hydroxide is preferably present in the range of from 10 to 40 weight percent of the aqueous solution. Also disclosed is additional incorporation into the electrolyte of a small amount of lithium hydroxide.

### BRIEF DESCRIPTION OF THE DRAWINGS

The above and other features and aspects of the present invention will become more apparent upon reading the following detailed description in conjunction with the accompanying drawings in which:

FIG. 1 illustrates the ionic conductivity of an electrolyte containing potassium pyrophosphate and potassium hydroxide in accordance with the principles of the present invention;

FIG. 2 illustrates an X-ray diffraction pattern of a calcium zincate constituent externally formed using the electrolyte of the present invention;

FIG. 3 illustrates the cycle life of an alkaline rechargeable nickel-zinc battery using the electrolyte of the present invention; and

FIG. 4 illustrates the discharge curve of an alkaline rechargeable nickel-zinc battery using the electrolyte of the present invention at −30° C.

### DETAILED DESCRIPTION OF THE INVENTION

In accordance with the principles of the present invention, the alkaline electrolyte of the invention contains an aqueous solution in which is dissolved potassium hydroxide and potassium pyrophosphate. Preferably, the amount of potassium pyrophosphate is in a range of from 0.5 to 40 weight percent of the aqueous solution. More preferably, the range of potassium pyrophosphate is from 0.5 to 10 weight percent. The potassium hydroxide is preferably present in the range of from 10 to 40 weight percent of the aqueous solution.

Also, in further accord with the invention, lithium hydroxide is additionally incorporated into the aqueous solution with the potassium hydroxide and the potassium pyrophosphate. Preferably, the lithium hydroxide is present in an amount of from 0.1 to 5 weight percent of the aqueous solution.

It has been found that an electrolyte with a constituent make-up as abovedescribed for the electrolyte exhibits good ionic conductivity and a low freezing point. Also, the electrolyte is compatible with calcium constituents and, in particular, with calcium zincate. The term “compatible” as used herein means that the calcium zincate constituents will be stable in the electrolyte at concentrations of potassium hydroxide in the electrolyte of higher than 20 weight percent of the aqueous solution. Moreover, it has also been found that rechargeable alkaline batteries using zinc negative electrodes, employing the electrolyte exhibit good cycle life, high rate capability and good low temperature performance. By low temperature is meant herein temperatures which are equal to or below −30° C.

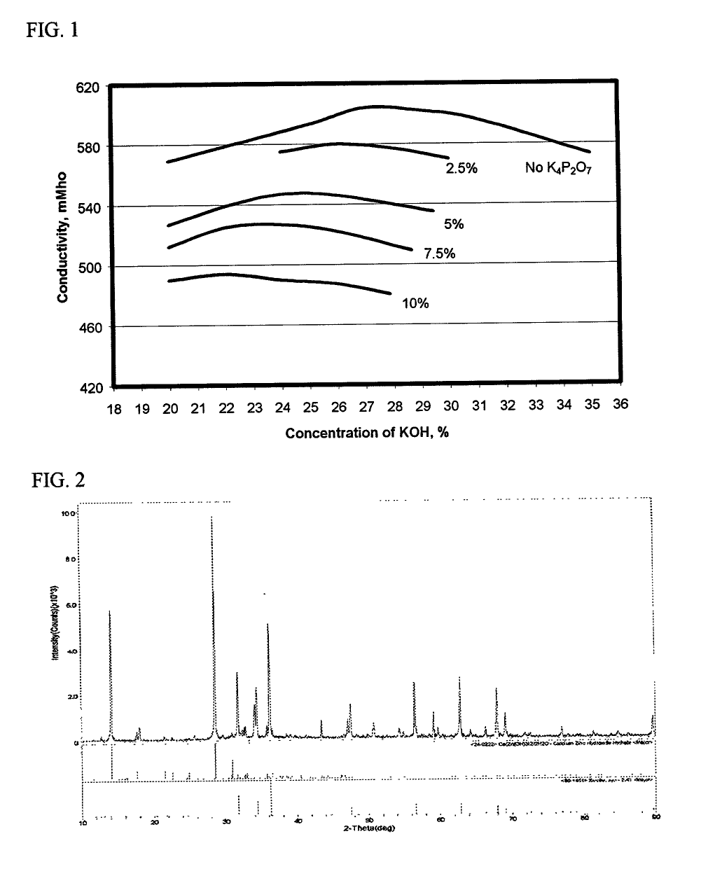

FIG. 1 plots the ionic conductivity change as a function of potassium concentration at selected potassium pyrophosphate concentrations of 2.5%, 5.0%, 7.5%, and 10.0% for the electrolyte of the invention. Each electrolyte solution is made from commercial potassium pyrophosphate, potassium hydroxide and de-ionized water. Each solution also contains lithium hydroxide at a concentration of 1.0%.

The conductivity of each solution is measured by using Traceable® expanded range digital conductivity meter at room temperature. As evidenced by FIG. 1 and as indicated above, the solutions exhibit a relatively high conductivity. This conductivity necessitated that a 10×detector with an expanded range conductivity meter be used during the tests.

FIG. 2 shows the X-ray diffraction (XRD) pattern of calcium zincate active material for use in the zinc negative electrode of a nickel-zinc rechargeable battery. The calcium-zincate active material is formed using the electrolyte of the present invention to demonstrate the compatibility of the calcium-zincate with the electrolyte.

More particularly, the calcium zincate material having the structural formula Ca[Zn(OH)₃]₂.2H₂O, is formed using the procedure described U.S. Pat. No. 5,863,676, issued to Allen Charkey. Stoichiometric amounts of Ca(OH)₂ and ZnO for forming of calcium zincate are placed into a beaker. An aqueous electrolyte solution in accordance with the invention containing potassium pyrophosphate and potassium hydroxide, for example 2% of potassium pyrophosphate and 26% of potassium hydroxide, is added into the beaker with a magnetic stirring bar. The reactants are stirred for 48 hours with a cover on the beaker.

At the end of this period, the solution/suspension is filtered (Whatman #2 filter paper), washed twice with the same aqueous electrolyte solution and vacuum dried. The XRD pattern of FIG. 2 shows that the main product is calcium zincate, having the structural formula Ca[Zn(OH)₃]₂.2H₂O. The peaks for zinc oxide are also detected while the peaks for calcium hydroxide are negligible. The result shows that calcium zincate, which is the active material for rechargeable nickel-zinc batteries, is compatible with the aqueous electrolyte solution of the invention.

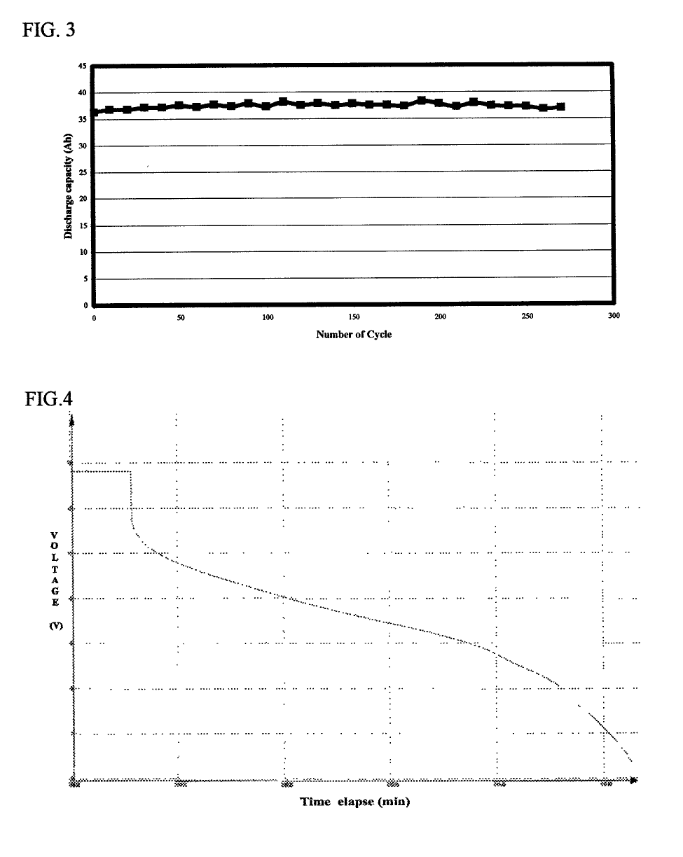

FIG. 3 shows the cycle life test of a 30 Ah, 12 V nickel-zinc rechargeable battery with the electrolyte of the invention containing an aqueous solution with 2% of potassium pyrophosphate and 26% of potassium hydroxide. The battery comprises 7 individual 30 Ah cells connected in series.

The cathode of the battery is a nickel hydroxide electrode. The electrodes are formed of 66 weight percent of nickel hydroxide, 30 weight percent of graphite and 4 weight percent of PTFE. The graphite can be coated with 5 weight percent of cobalt oxide as described in U.S. Pat. No. 4,546,058, issued to Allen Charkey. The anode or negative electrode of the battery is a zinc oxide electrode. The electrodes are formed of 65 weight percent of zinc oxide, 25 weight percent of calcium hydroxide, 8 weight percent of lead oxide and 2 weight percent of PTFE. The integral layers for cathode and anode are fabricated via a plastic bonding process as described in U.S. Pat. No. 4,976,904, issued to John M. Bilhorn.

The cathodes and anodes are formed in accordance with U.S. Pat. No. 5,863,676, issued to Allen Charkey. More particularly, two nickel hydroxide layers are laminated on both faces of perforated nickel foil with electrical attachment tabs. The zinc active layer is laminated to one face of a current collector which is formed from a perforated copper foil with an electrical attachment tab. The perforated copper foil is preferably plated with a metal such as silver, lead, tin or zinc.

A PTFE film element having a thickness of 5 mil is then bonded to the opposite face of the current collector to form a hydrophobic gas recombination element. This assembly constitutes the first part of a split anode. A second part of the split anode is formed identically to the first part except that the PTFE film element is not bonded on the current collector. The composite electrode is formed by adjoining the first and second parts so that the PTFE film element of the first split part abuts the current collector of the second split part.

The cathodes and anodes are interspersed in an alternating fashion to form a battery electrode assembly with Celgard® 3406, micro-porous polypropylene film as manufactured by Celgard Charlotte, N.C., as separator and with Pellon, an absorbent nylon material as manufactured by Freudenburg, Lowell, Mass., as absorber. The Celgard® film is 1 mil in thickness and the Pellon is 5 mils in thickness.

The battery electrode assembly is inserted in a plastic prismatic case. The cover assembly comprises two electrical terminals and a through-hole opening. The cathode tabs are welded onto the positive terminal and the anode tabs are welded onto the negative terminals. The case and cover are sealed ultrasonically. The electrolyte of 2% of potassium pyrophosphate and 26% of potassium hydroxide is injected via the through-hole opening. A resealable pressure safety vent that allows the safe operation of the battery is fitted and solvent welded on the through-hole opening. The completed nickel-zinc cell is then placed on a formation machine. The cell is charged/discharged 3 cycles to electrochemically form the electrodes.

Seven such kind of formed cells are connected in series via nickel-plated copper intercell connectors. The battery is rated at nominal capacity of 30Ah with a nominal voltage of 12 V.

The battery is cycled with a regime of charging at a 2-hour rate and discharging at a 3-hour rate to 8.4V, which is equivalent to 1.2 V per cell. The depth of discharge (DOD) is a hundred percent for this discharge regime. FIG. 3. shows the discharge capacity as a function of cycling. After more than 250 cycles, the battery still delivers above the rated capacity.

FIG. 4 is a typical discharge curve of the battery of FIG. 3 containing the electrolyte of the invention at −30° C. at 20A discharge. The −30° C. discharges are performed periodically at every 25 cycles. The above charge and discharge regime is adopted for this test at room temperature. After 25 cycles, the battery is charged at the same charge regime and then placed inside a temperature chamber at −30° C. for 16 hours. The battery is discharged at 20A to 6.3V at −30° C.

As can be seen from FIG.4, the battery can deliver more than 20% of its rated capacity during discharge at −30° C. In comparison, a battery with a conventional electrolyte, which is 20% KOH aqueous solution, can only deliver 5 to 30 % of its rated capacity at −20° C., while the battery is not usable at a temperature under −25° C. Moreover, while batteries with a 31% KOH aqueous solution can deliver around 20% of their rated capacity at −30° C., the capacities of such batteries decay rapidly, and they are only capable of 100 cycles with 100% DOD.

In all cases, it is understood that the above-described arrangements are merely illustrative of the many possible specific embodiments which represent applications of the present invention. Numerous and varied other arrangements can readily be devised in accordance with the principles of the present invention without departing from the spirit and scope of the invention. Thus, for example, the electrolyte of the invention can be used with batteries having a variety of different types of positive electrodes. Typical positive electrodes might include electrodes having active material selected from one of nickel hydroxide/nickel oxy-hydroxide, silver/ silver oxide, manganese oxide, oxygen and Mₓ[FeO₄⁻]y, where M is one of the alkaline metal, alkaline earth metal and rare-earth metal.

What is claimed is:

1. An electrolyte for use in a rechargeable battery with a zinc negative electrode comprising :an aqueous solution; and potassium pyrophosphate and potassium hydroxide dissolved in said aqueous solution.

2. An electrolyte in accordance with claim 1 wherein: said potassium pyrophosphate is present in the range of 0.5 to 40 weight percent of said aqueous solution.

3. An electrolyte in accordance with claim 2 wherein: said potassium pyrophosphate is present in the range of 0.5 to 10 weight percent of said aqueous solution.

4. An electrolyte in accordance with claim 1 wherein: said potassium hydroxide is present in the range of 10 to 40 weight percent of said aqueous solution.

5. An electrolyte in accordance with claim 1 further comprising lithium hydroxide dissolved in said aqueous solution.

6. An electrolyte in accordance with claim 5 wherein: said lithium hydroxide is present in the range of 0.1 to 5 weight percent of the aqueous solution.

7. An alkaline battery comprising: a positive electrode; a zinc negative electrode; separator materials separating said positive and negative electrodes; and an electrolyte, said electrolyte including: an aqueous solution; and potassium pyrophosphate and potassium hydroxide dissolved in said aqueous solution.

8. An alkaline battery in accordance with claim 7 wherein: said positive electrode compromises one of nickel hydroxide/nickel oxy-hydroxide, silver/silver oxide, manganese oxide, Mₓ[FeO₄⁻]_{y} and oxygen.

9. An alkaline battery in accordance with claim 8 wherein: said M is one of an alkaline metal, alkaline earth metal and rare-earth metal.

10. An alkaline battery in accordance with claim 7 wherein: said negative electrode compromises one of zinc, zinc/zinc oxide and zinc oxide.

11. An alkaline battery in accordance with claim 10 wherein: said zinc/zinc oxide comprises a calcium zincate constituent.

12. An alkaline battery in accordance with claim 7 wherein: said aqueous solution is present in a range of 2 to 30 weight percentage of the battery.

13. An alkaline battery in accordance with claim 7 wherein: said potassium pyrophosphate is present in the range of 0.5 to 40 weight percent of said aqueous solution.

14. An alkaline battery in accordance with claim 13 wherein: said potassium pyrophosphate is present in the range of 0.5 to 10 weight percent of said aqueous solution.

15. An alkaline battery accordance with claim 7 wherein: said potassium hydroxide is present in the range of 10 to 40 weight percent of said aqueous solution.

16. An alkaline battery in accordance with claim 7 wherein: said electrolyte further comprises lithium hydroxide dissolved in said aqueous solution.

17. An alkaline battery in accordance with claim 16 wherein: said lithium hydroxide is present in the range of 0.1 to 5 weight percent of the aqueous solution.
